(19) United States
(12) Patent Application Publication
(10) Pub. No.: US 2011/0218821 A1
(43) Pub. Date: Sep. 8, 2011

(54) HEALTH CARE DEVICE AND SYSTEMS AND METHODS FOR USING THE SAME

(76) Inventors: Matt Walton, Westport, CT (US); Ryan O'Connell, North Haven, CT (US); Michael Winser, Westport, CT (US)

(21) Appl. No.: 12/968,897

(22) Filed: Dec. 15, 2010

Related U.S. Application Data
(60) Provisional application No. 61/286,562, filed on Dec. 15, 2009.
(60) Provisional application No. 61/311,129, filed on Mar. 5, 2010.

(51) Int. Cl. G06Q 50/00; G06Q 10/00

(52) U.S. Cl. 705/3; 705/2

(57) ABSTRACT

The invention described herein solves the challenges encountered in searching for medical/clinical information from multiple data sources. Systems, methods, and devices of the invention allow a user to search a number of dissimilar information sources simultaneously, and view, process, and perform correlations on the information. The invention uses faceted search to process clinical values, subject characteristics, and population characteristics, thereby providing a user with an array of information useful for monitoring or improving the state of health of a patient or a patient population. The invention enables a user to evaluate information in a patient-centric way, and analyze information at either the individual or the population level.

This application claims priority to U.S. Provisional Application No. 61/286,562, filed on Dec. 15, 2009, and U.S. Provisional Application No. 61/311,129, filed on Mar. 5, 2010, each of which is incorporated by reference in its entirety.

### BACKGROUND

Most health care data systems have evolved to support specific departments or functions—not necessarily to simplify a physician's or patient's desire to (i) meaningfully reduce medical errors by having physician access to a complete view of all of the information being collected on patients in multiple data silos between and within hospitals, physician's offices, clinics, nursing homes, prisons, correctional facilities, and long term care services; (ii) improve the work flow of health care providers; and (iii) provide much-desired information to patients and their families at every stage of the health care delivery process. In fact, health care facilities are commonly configured such that the emergency department, wards, laboratories, pharmacies, care givers and support persons are each supported by different systems, each configured to support the specific requirements of those functions, and not designed to be cross-functional or interoperable. Such deficiencies adversely affect the delivery of care to individual patients, and impede the delivery and improvement of care across multiple patients.

### SUMMARY OF THE INVENTION

In some embodiments, the invention provides a method of accessing data from a plurality of independent data sources, the method comprising using a device to operate a faceted search system to: a) access, retrieve, process, and display data from the plurality of independent data sources; b) perform context-free transformations using data from the independent data sources; c) correlate data from the independent data sources; and d) query and present information in a user-defined format without a query tool that can interpret or reference a boundary descriptor or a format of the source data.

In some embodiments, the invention provides a device that is effective to: a) use faceted search to access, retrieve, process, and display data from a plurality of independent data sources; b) perform context-free transformations using data from the independent data sources; c) correlate data from the independent data sources; and d) query and present information in a user-defined format without a query tool that can interpret or reference a boundary descriptor or a format of the source data.

### BRIEF DESCRIPTION OF THE FIGURES

FIG. 1 is a block diagram illustrating a first example architecture of a computer system that can be used in connection with example embodiments of the present invention.

FIG. 2 is a diagram illustrating a computer network that can be used in connection with example embodiments of the present invention.

FIG. 3 is a block diagram illustrating a second example architecture of a computer system that can be used in connection with example embodiments of the present invention.

FIG. 4 is a block diagram illustrating a non-limiting embodiment of the invention.

### DETAILED DESCRIPTION

The invention disclosed herein overcomes historical obstacles against accessing, retrieving, transforming, and using health records and medical information by using novel search technology combined with novel clinical support processes, algorithms, and care paths to make patient-centric and population-level information available to health care providers, patients and their families, caregivers, attendants, and those associated with the performance of health care tasks on both telecommunications devices and network or web-based access clients. An aspect of novelty of the invention is that the invention provides the access and organization of all relevant information for an individual patient or a group of patients.

The invention disclosed herein solves the daily challenge of providing physicians, patients, and families with access to critical health information when, where, and how they need the information. The invention provides a novel device, and systems and methods for using the same, comprising a novel medical dashboard that is securely or insecurely accessible on a network or a telecommunications device by healthcare providers, patients and their families, caregivers, attendants, and those associated with the performance of health care tasks. The instant invention organizes relevant patient information by screening institutional data silos to overcome the difficulties inherent in traditional integration approaches requiring custom interfaces, applications, conversions through proprietary or open standards, and/or database modification. Embodiments of the instant invention access data from all aspects of the relevant systems, and make data available in a user-formatted context that enables users to make better decisions and produce better clinical outcomes via improved searching.

The invention combines several means to access, retrieve, process, and display information from existing databases in an integrated application. Non-limiting examples of the means include: 1) the use of faceted search to access, retrieve, process, and display data from one or more existing systems regardless of the schema of each system's data for health records and medical information; 2) the ability to perform context-free transformations using existing data structures instead of having to model two-way inter-record and/or intra-record transformations; 3) the ability to correlate data from a plurality of independent sources, regardless of their existing schema, based on one or more clinical values, population characteristics, and/or subject characteristics, wherein the existing schema of the sources may be the same schema for each source, or a plurality of schema; 4) the ability to create virtual documents with a shared context, which represent a collection of documents dynamically configured to meet user-defined requirements; and 5) the ability to query and present information in a form that meets a variety of user-defined requirements without the need for query tools to be able to interpret or reference a boundary descriptor or a format of the source data.

The result of the integration of any combination, or all, of these means is the creation of an application that can be quickly and easily applied to large, complex, multi-source data structures to access, retrieve, process, and display health records and medical information. The invention provides users with context-relevant information without altering or interfering with any of the underlying data sources and structures. The invention permits users to define their own contexts for the display of information from multiple sources with the ability to set their own parameters for the extraction and display of the underlying data.

In some embodiments, the invention provides a method of accessing data from a plurality of independent data sources, the method comprising using a device to operate a faceted search system to: 1) access, retrieve, process and display data from one or more existing systems regardless of the schema of each system's data for health records and medical information; 2) perform context-free transformations using existing data structures instead of having to model two-way inter-record and/or intra-record transformations; 3) correlate data from a plurality of independent sources, regardless of their existing schema, based on one or more clinical values, population characteristics, and/or subject characteristics, wherein the existing schema of the sources may be the same schema for each source, or a plurality of schema; 4) create virtual documents with a shared context, which represent a collection of documents dynamically configured to meet user-defined requirements; and/or 5) query and present information in a form that meets a variety of user-defined requirements without the need for specific application code that understands the meaning, or the original context, of the source data.

In some embodiments, the method is effective to do all of 1)-5).

In some embodiments, the invention provides a method of accessing data from a plurality of independent data sources, the method comprising using a device to operate a faceted search system to: 1) access, retrieve, process, and display data from the plurality of independent data sources; 2) perform context-free transformations using data from the independent data sources; 3) correlate data from the independent data sources; and/or 4) query and present information in a user-defined format without the need for query tools to be able to interpret or reference a boundary descriptor or a format of the source data.

In some embodiments, the method is effective to do all of 1)-4).

In some embodiments, the invention provides a method of accessing data from a plurality of independent data sources, the method comprising using a device to operate a faceted search system to: 1) access, retrieve, process, and display data from one or more existing systems regardless of the schema of each system's data, and without directly mapping any portion of the device of the invention to one or more portions of the underlying data source; 2) use read-only caches of external data, wherein the device of the invention uses simple data type conversions instead of having to model two-way inter-record and/or intra-record transformations; 3) correlate data from a plurality of independent sources, regardless of their existing schema, based on one or more clinical values, population characteristics, and/or subject characteristics, wherein the existing schema of the sources may be the same schema for each source, or a plurality of schema; and/or 4) query and present information in a form that meets a variety of user-defined requirements without the need for query tools to be able to interpret or reference a boundary descriptor or a format of the source data.

In some embodiments, the method is effective to do all of 1)-4).

In some embodiments, the invention contemplates a device that is effective to: 1) use faceted search to access, retrieve, process, and display data from one or more existing systems regardless of the schema of the system's data for health records and medical information; 2) perform context-free transformations using existing data structures instead of having to model two-way inter-record and/or intra-record transformations; 3) correlate data from a plurality of independent sources regardless of their existing schema based on one or more clinical values, population characteristics, and/or subject characteristics, wherein the existing schema of the sources may be the same schema for each source, or a plurality of schema; 4) create virtual documents with a shared context, which represent a collection of documents dynamically configured to meet user-defined requirements; and/or 5) query and present information in a form that meets a variety of user-defined requirements without the need for query tools to be able to interpret or reference a boundary descriptor or a format of the source data.

In some embodiments, the device is effective to do all of 1)-5).

In some embodiments, the invention contemplates a device that is effective to: 1) use faceted search to access, retrieve, process, and display data from one or more existing systems regardless of the schema of each system's data, and without directly mapping any portion of the device of the invention to one or more portions of the underlying data source; 2) use read-only caches of external data, wherein the device of the invention uses simple data type conversions instead of having to model two-way inter-record and/or intra-record transformations; 3) correlate data from a plurality of independent sources regardless of their existing schema based on one or more clinical values, population characteristics, and/or subject characteristics, wherein the existing schema of the sources may be the same schema for each source, or a plurality of schema; and/or 4) query and present information in a form that meets a variety of user-defined requirements without the need for query tools to be able to interpret or reference a boundary descriptor or a format of the source data.

In some embodiments, the method is effective to do all of 1)-4).

In some embodiments, the invention contemplates a device that is effective to: 1) use faceted search to access, retrieve, process, and display data from one or more existing data systems regardless of the schema of each data system's data, and without directly mapping any portion of the device to one or more portions of the underlying data system; 2) perform context-free transformations using existing data structures; 3) correlate data from a plurality of independent data sources; and/or 4) query and present information in a form that meets a variety of user-defined requirements without the need for query tools to be able to interpret or reference a boundary descriptor or a format of the source data.

In some embodiments, a device is effective to do all of 1)-4).

In some embodiments, at least one existing data system or independent data source stores health records and/or medical information.

In some embodiments, the device does not map any portion of the device to any portion of the existing data systems or independent data sources.

For illustrative examples of principles, methods, and applications of faceted search, see David Smiley & Eric Pugh, SOLR 1.4 ENTERPRISE SEARCH SERVER (Packt Publishing 2009), which is incorporated herein by reference in its entirety.

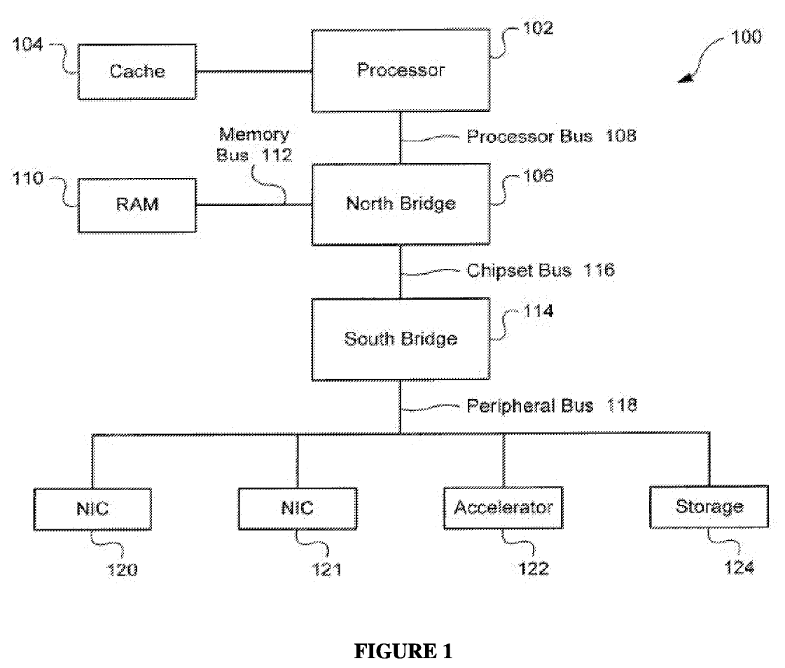

FIG. 1 is a block diagram illustrating a first example architecture of a computer system 100 that can be used in connection with example embodiments of the present invention. As depicted in FIG. 1, the example computer system can include a processor 102 for processing instructions. Non-limiting examples of processors include: Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can also be used, whether in a single computer system, in a cluster, or distributed across systems over a network comprising a plurality of computers, cell phones, and/or personal data assistant devices.

As illustrated in FIG. 1, a high speed cache 104 can be connected to, or incorporated in, the processor 102 to provide a high speed memory for instructions or data that have been recently, or are frequently, used by processor 102. The processor 102 is connected to a north bridge 106 by a processor bus 108. The north bridge 106 is connected to random access memory (RAM) 110 by a memory bus 112 and manages access to the RAM 110 by the processor 102. The north bridge 106 is also connected to a south bridge 114 by a chipset bus 116. The south bridge 114 is, in turn, connected to a peripheral bus 118. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 118. In some alternative architectures, the functionality of the north bridge can be incorporated into the processor instead of using a separate north bridge chip.

In some embodiments, system 100 can include an accelerator card 122 attached to the peripheral bus 118. The accelerator can include field programmable gate arrays (FPGAs) or other hardware for accelerating certain processing. For example, an accelerator can be used for adaptive data restructuring or to evaluate algebraic expressions used in extended set processing.

Software and data are stored in external storage 124 and can be loaded into RAM 110 and/or cache 104 for use by the processor. The system 100 includes an operating system for managing system resources; non-limiting examples of operating systems include: Linux, Windows™, MACOS™, BlackBerry OS™, iOS™, and other functionally-equivalent operating systems, as well as application software running on top of the operating system for managing data storage and optimization in accordance with example embodiments of the present invention.

In this example, system 100 also includes network interface cards (NICs) 120 and 121 connected to the peripheral bus for providing network interfaces to external storage, such as Network Attached Storage (NAS) and other computer systems that can be used for distributed parallel processing.

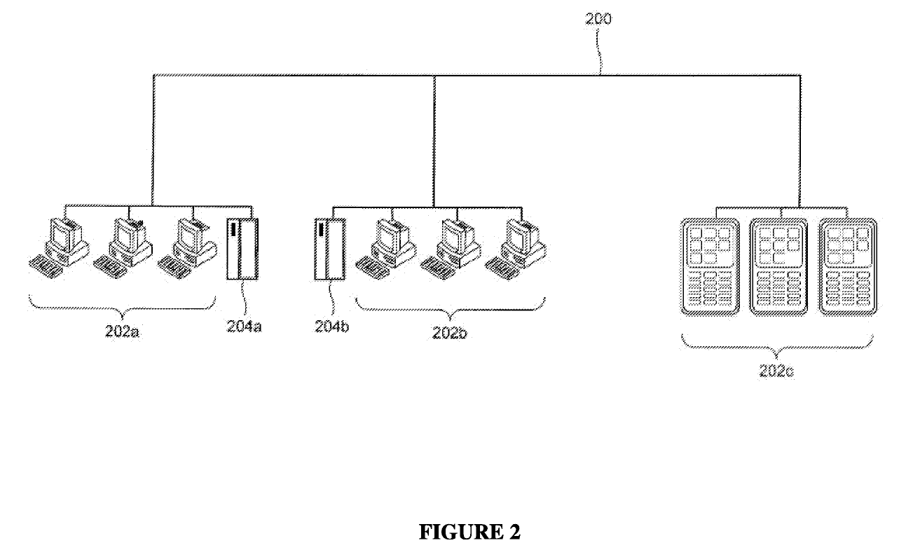

FIG. 2 is a diagram showing a network 200 with a plurality of computer systems 202a, and 202b, a plurality of cell phones and personal data assistants 202c, and Network Attached Storage (NAS) 204a, and 204b. In example embodiments, systems 202a, 202b, and 202c can manage data storage and optimize data access for data stored in Network Attached Storage (NAS) 204a and 204b. A mathematical model can be used for the data and be evaluated using distributed parallel processing across computer systems 202a, and 202b, and cell phone and personal data assistant systems 202c. Computer systems 202a, and 202b, and cell phone and personal data assistant systems 202c can also provide parallel processing for adaptive data restructuring of the data stored in Network Attached Storage (NAS) 204a and 204b. FIG. 2 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some example embodiments, processors can maintain separate memory spaces and transmit data through network interfaces, back plane or other connectors for parallel processing by other processors. In other embodiments, some or all of the processors can use a shared virtual address memory space.

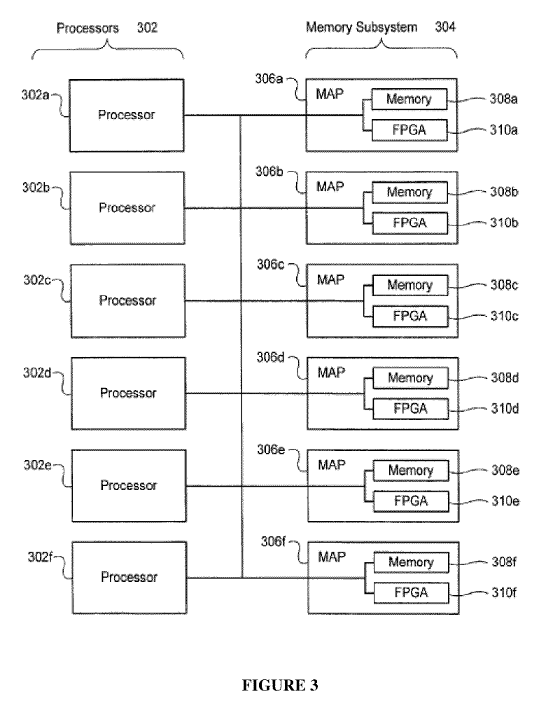

FIG. 3 is a block diagram of a multiprocessor computer system 300 using a shared virtual address memory space in accordance with an example embodiment. The system includes a plurality of processors 302a-f that can access a shared memory subsystem 304. The system incorporates a plurality of programmable hardware memory algorithm processors (MAPs) 306a-f in the memory subsystem 304. Each MAP 306a-f can comprise a memory 308a-f and one or more field programmable gate arrays (FPGAs) 310a-f. The MAP provides a configurable functional unit and particular algorithms or portions of algorithms can be provided to the FPGAs 310a-f for processing in close coordination with a respective processor. For example, the MAPs can be used to evaluate algebraic expressions regarding the data model and to perform adaptive data restructuring in example embodiments. In this example, each MAP is globally accessible by all of the processors for these purposes. In one configuration, each MAP can use Direct Memory Access (DMA) to access an associated memory 308a-f, allowing it to execute tasks independently of, and asynchronously from, the respective microprocessor 302a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. In some embodiments, all or part of the data management and optimization system can be implemented in software or hardware and that any variety of data storage media can be used in connection with example embodiments, including random access memory, hard drives, flash memory, tape drives, disk arrays, Network Attached Storage (NAS) and other local or distributed data storage devices and systems.

In example embodiments, the data management and optimization system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 3, system on chips (SOCs), application specific integrated circuits (ASICs), or other processing and logic elements. For example, the Set Processor and Optimizer can be implemented with hardware acceleration through the use of a hardware accelerator card, such as accelerator card 122 illustrated in FIG. 1.

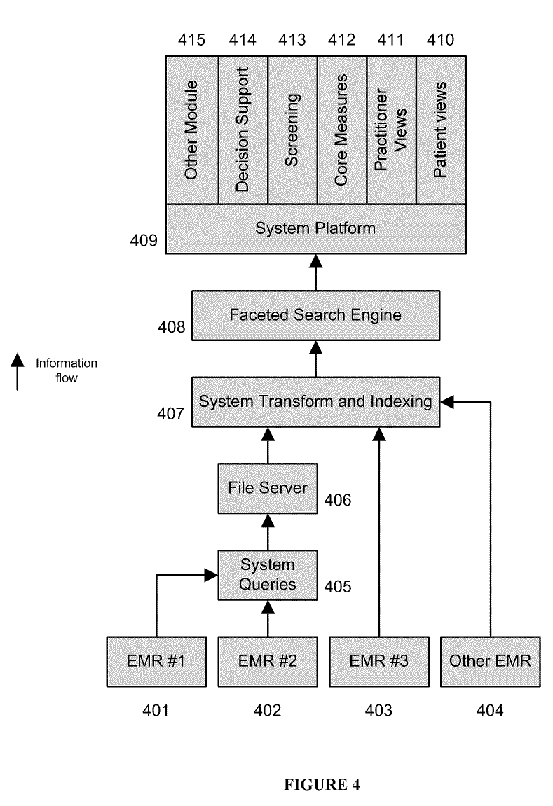

FIG. 4 depicts an illustrative, non-limiting embodiment of the invention. FIG. 4 illustrates the flow of information from various information resources to the system platform. Information is accessible from a plurality of electronic medical record (EMR) systems 401, 402, 403, and 404. The EMRs can be in-house, or local, systems (401, 402, and 403), operated by the institution using the system of the invention, or can be an EMR located remotely (404), and administrated, owned, and operated by a different institution or entity. The different institution or entity can be a partner of the institution operating the system of the invention, or can be publicly-accessible. An EMR can be any kind of information system described herein.

System queries 405 represent search protocols designed to retrieve information from one or more EMRs. The information can be that which is needed or desired by the system platform or the user of the system platform, or can be information that the system or the user does not realize is beneficial, relevant, or available. System queries 405 can be designed to run at the user's direction, or at intervals. For example, a system query can be queued to run a baseline query daily and partial queries at preset intervals determined by either the user or the system platform.

Results of the system queries 405 are sent to a file server 406, where the results can be stored for any length of time. The file server 406 can share the query results with any number of system platforms that have data-sharing privileges.

Information contained in the file server 406 is then subjected to system transform and indexing 407. Information can also be transformed and indexed directly from a local EMR (403) or a remote EMR (404) to provide direct HL7 feeds of medical, clinical, and administrative information. The transformation of data from the one or more data sources is a context-free transformation, and the transformed information is compiled into an index for the faceted search engine 408.

The faceted search engine 408 allows the user to execute search functions on the system, and can access all transformed and indexed information 407. Once the faceted search engine 408 has acquired search results, the results are sent to system platform 409, which is the platform for applications of systems of the invention.

The system platform 409 supports a variety of application modules 410-415. The modules provide the user with a variety of interface options and post-search processes. The patient view module 410 can be optimized to provide a patient with, for example, information that can assist the patient in evaluating the current state of health and sustaining or improving the quality of life. The practitioner view module 411 can be optimized to provide a healthcare practitioner with, for example, information pertinent to monitoring, evaluating, diagnosing, or caring for a patient or a population of patients.

The core measures module 412 allows a user to compare the treatment of a patient or a population against evidence-based, standardized performance measures.

The screening module 413 allows a user to screen information from the data sources rapidly without the need to know which data source provided the information.

The decision support module 414 provides a user with information and interpretations of information, for example, correlative graphs, useful for making a decision in a healthcare initiative. For example, the decision support module 414 can provide a physician with a list of medications that could be administered for a certain indication.

The other module 415 can be a user-defined application designed to optimize the acquisition, display, or processing of information, and is not limited to the embodiments described herein.

“Context,” can describe, generally, the boundary descriptors or format information used in an information system to understand or interpret the data contained therein. Similarly, a “context-free” process is a process that does not require aforementioned context. A “context-free transformation” is any data transformation protocol known to one of skill in the art, executed in such a way that context is unnecessary. In some embodiments, a device or system of the invention can search for, transform, present, and/or correlate data without the need for the query tools to be able to interpret or reference a boundary descriptor or a format of one or more host systems. The ability of a system or device of the invention to query and present information in a user-defined format without the need for query tools to be able to interpret or reference a boundary descriptor or a format of one or more host systems can be thought of as the lack of a need for application code that understands the meaning or the original context of the source data.

Query tools, generally, can be any software system known to one of skill in the art that allows a user to access information stored in a database, data system, or data source.

In some embodiments, the device creates virtual documents with a shared context, and can create a collection of virtual documents configured, or dynamically configured, to meet user-defined requirements, for example, a format, configuration, graph, table, plot, list, patient profile, population profile, user profile, statistical breakdown, inventory, timeline, or display. In some embodiments, the dynamic configuration allows multiple users to configure documents differently, or change the configuration of existing documents.

A clinical value can be any data that can be used to describe and/or assess the general state of health of a patient. Non-limiting examples of clinical values include: blood pressure, pulse, pulse oximetry, cholesterol level, blood sugar, respiration rate, weight, strength, metabolism, and changes in any of the forgoing.

A subject characteristic can be any information that describes the general status of a subject, such as a patient. Non-limiting examples of subject characteristics include: clinical values; demographic information; personal information such as, name, date of birth, date of admission, date of discharge, etc.; indications; past indications; prescriptions; and medical orders.

A population characteristic can be any subject characteristic considered more generally for a population of subjects and optionally analyzed statistically. Non-limiting examples of populations that can produce population characteristics include: current patients in a facility; past patients in a facility; a population of a defined geographic region; and a population defined by a specific characteristic, such as age, prescriptions, diagnosis, complaints, symptoms, indications, etc.

One of skill in the art will recognize that any independent data source, data structure, or data system can be characterized by a scheme for the organization or coding of data. Within a plurality of independent data sources, data structures, and/or data systems, the independent data sources, data structures, and/or data systems can have the same schema, similar schema, dissimilar schema, different schema, or schema that are mutually incompatible. A device and/or system of the invention can perform any function described herein on any plurality of independent data sources, data structures, and/or data systems regardless of the varying natures of the schema characteristic of the independent data sources, data structures, and/or data systems. For example, a device and/or system of the invention can access, retrieve, process, and display data from a plurality of independent data sources, data structures, and/or data systems having the same schema, similar schema, dissimilar schema, different schema, or schema that are mutually incompatible. The independent data sources, data structures, and/or data systems can be searched simultaneously or sequentially.

The invention also provides methods of using any device described herein. In some embodiments, the use of the invention takes place under control of a client system. In some embodiments, the device is used to access, retrieve, process, and display health records and/or medical information.

Table 1 lists non-limiting examples of clinical values, population characteristics, and subject characteristics. Clinical values broadly describe information surrounding clinical procedures and observations. Population characteristics broadly encompass information describing a population of patients or subjects, for example, associated with a health care institution or provider or patient demographics. Subject characteristics broadly encompass information describing a subject of interest to a user of a device of the invention, the subject being a human, for example, a patient or relative, associate, or representative thereof.

In some embodiments, the device is a telecommunications device. In some embodiments, the device is hand-held. Non-limiting examples of suitable devices include telephones, personal data assistants, and computers. In some embodiments, the device acts as a client capable of simultaneously accessing a plurality of unrelated servers. In some embodiments, the client can process information received from a plurality of servers to arrive at a result that could not be obtained from any one of the plurality of servers. Non-limiting examples of the result include data, a diagnosis, a comparison, a recommendation, a correlation, a prediction, a trend, and an alert.

In some embodiments, a data system is a healthcare record system, such as a file, archive, legacy, database, or case history. The record system may be maintained by one or more clinics, hospitals, hospices, offices, private physicians, veterinary clinics, academic institutions, government agencies, private agencies, military agencies, correctional facilities, and insurance carriers.

An unexpected result of the invention is the ability of a device to capture a stream of data from one or more sources without the need to map, store, or mirror the data from the source onto the device. In some embodiments, the device does not internalize data from a data source. In some embodiments, the abilities of the device are independent of the nature or number of schema used by a plurality of data sources. The ease and speed at which the device can be incorporated into an existing health care system is faster than one of skill in the art would expect based on knowledge of modern search technologies.

An unexpected result of the invention is that the ability of a device to operate with context-free transformations obviates the need to model two-way inter-record and/or intra-record transformations. This result increases the rate at which data can be accessed and interpreted.

An unexpected result of the invention is the ability of a device to function effectively without the need for specific application code that understands the meaning, or the original context, of the source data. Ordinarily, a data-retrieval system would require the ability to understand the meaning, or the original context, of the source data; for example, ordinarily a data-retrieval system would need query tools that can interpret or reference a boundary descriptor or a format of a data system.

In some embodiments, the device functions effectively without application code that understands the meaning, or the original context, of the source data. In some embodiments, the device functions effectively without the need for the query tools that can interpret or reference a boundary descriptor or a format of one or more data systems. In some embodiments, the device functions effectively without application code that is compatible with the meaning, or the original context, of the source data. In some embodiments, the device functions effectively without application code that interfaces with the meaning, or the original context, of the source data. In some embodiments, the device functions effectively without application code that is the same as the application code of the source data. In some embodiments, a device and/or system of the invention use a code that is different from the code used by the independent data sources. In some embodiments, the device and/or system of the invention uses a first code, the independent data sources use a second code, and the first code and the second code are not the same.

The device and the operating systems associated with the device are able to correlate search results regardless of whether or not the user intended for the results to be correlated, thereby identifying correlations that are unexpected, surprising, and useful to the user. Non-limiting examples of means of finding correlations include logic, language, clinical history, previous search results, inference, medical diagnosis, and health care knowledge. For example, searching for information on a patient characterized by both an indication and specific drug tolerances could return search results identifying an appropriate therapy directed towards that indication that was used successfully in other patients with similar drug tolerances.

In some embodiments, the invention contemplates a method of accessing data from at least one data source, the method comprising: using a faceted search device to access, retrieve, process, and display data from at least one data source. In some embodiments, the method does not include a step of mapping a portion of the device to one or more portions of the underlying data system.

In some embodiments, the method further comprises generating a read-only cache of external data. In some embodiments, the read-only cache is generated from simple data type conversions. In some embodiments, a read-only cache is temporary. In some embodiments, a read-only cache is generated in response to the most recently input search string.

In some embodiments, the system performs context-free transformations. In some embodiments, the system performs context-free transformations using existing data structures.

In some embodiments, the method further comprises correlating data from a plurality of independent data sources. In some embodiments, the efficacy of this step is independent of the identities of the schema of the data sources.

In some embodiments, the method further comprises querying and presenting information in a form that meets a variety of user-defined requirements without the need for specific application code that understands the meaning, or the original context, of the source data.

In some embodiments, a system of the invention autonomously and periodically scans streams of data and changes in the information stored in one or more databases. The system can search with or without a direct order from the user. A user can create search terms to be used once, repeatedly, or periodically. The system of the invention can scan for data, for example, continuously, daily, hourly, several times an hour, or every minute if the user desires.

A system of the invention can support any number of users, who can be, for example, physicians, clinicians, patients, caregivers, attendants, or security personnel. Each user can create a user profile, and edit the profile at any time. Non-limiting examples of fields incorporated into a profile include: name, title/position, department, specialty, login identification, password, work schedule, associated patients, and current location.

In some embodiments, one or more superusers can create, access, and/or modify any user profiles. A superuser can be a person with supervisory authority over the users, for example, the head of a clinical department, head of security, or head of an information technology program.

A user can assign a threshold level to a clinical value or characteristic of a subject. The clinical value or characteristic can be monitored by conventional means, such as by a medical monitoring device, and entered into a health care database by conventional means. Upon scanning the data system, a system of the invention obtains the new identity of the value or characteristic and alerts the user when the threshold level has been met. Thus, the system enables close and conscientious monitoring of values and characteristics by passive, non-intrusive, convenient means. Non-limiting examples of an alert include: a visual alert, such as a colored and/or flashing/blinking light; an audible alert; such as a tone or a prerecorded voice message; and a textual alert, such as an e-mail or a text message.

Non-limiting examples of medical monitoring devices compatible with systems of the invention include: blood pressure units, pulse oximeters, oxygen concentrators, glucometers, thermometers, infusion equipment, IV delivery devices, suction machines, portable oxygen units, and continuous positive airway pressure devices.

For example, a physician monitoring a patient's blood pressure can determine a threshold level for the patient's blood pressure. The patient's blood pressure is monitored by conventional methods and the blood pressure value is periodically entered into a medical database. Each time the system of the invention scans the database, the system will observe the most recent blood pressure value, and optionally, trends in blood pressure values. The physician can pre-determine a threshold value for the patient's blood pressure, and request notification when the blood pressure reaches that threshold. When the blood pressure reaches the threshold level, the system notifies the physician. This capability enables a user, such as a physician, to become aware of a value or characteristic that the physician might not be actively monitoring or even perceive as an immediate risk factor.

Similarly, as patient laboratory data become available, the physician or user can become aware of results of tests that were run without the physician's knowledge. Thus, the system can provide the physician with potentially useful information that the physician might not know is available or critical.

Searching for a specific therapy can provide the user with a list of therapies similar to that which was searched. Such search results can provide the user with options that the user might not have known were available, thereby providing the user with a greater scope of alternatives and a higher probability of identifying a desirable outcome. For example, a user can search the system for information on a medication, or for a list of equivalent medications. Equivalent medications are expected to provide similar clinical outcomes upon administration, but might be associated with different allergies, drug interactions, and side affects. The ability of the system to provide the user with a list of alternative medications increases the likelihood of identifying the best possible medication for the patient at hand. In this regard, the system allows the user to focus a search strategy on a patient, whereas conventional search methods focus on a condition or indication.

The system can maintain a record of recent or historical searches, and correlate those searches to, for example, a user, a patient, a health condition, a diagnosis, a prescription, a medical order, a health care facility, or any combination of the foregoing. Thus, the system can repeat previous searches to provide updated information, and if desired by the user, automatically compare new search results with the previous search results. The user can instruct the system to update a search periodically and make qualitative and quantitative comparisons of the search results periodically. Such update searches can self-execute even if the user is not concurrently engaged with a client device that operates the system. For example, a user, such as a physician, can instruct the system to alert the physician every time a certain patient is administered a medication, the amount of the medication, historical administration of the medication, potential side effects or incompatibilities with the medication, and past instances of adverse events to the medication. The search can also provide other forms of information, triggered by the search terms used, that are not necessarily the search results that one would have expected. This aspect of the invention provides the user with the opportunity to access information that the user might not have realized was available or relevant, and the user can make a professional judgment regarding the use of the unexpected search results. This aspect of the invention also ensures that the scope of the search results are not strictly limited by the searching skill and techniques of the user, and that important information will not go undiscovered by a novice user.

A system of the invention can archive the searches and results thereof, which were performed on devices associated with the system. The archive can be searched in future searches to provide more rapid search results when search terms are repeated in the future.

The archive also provides historical information, which can be used to monitor information over time. The activities of a healthcare institution can be entered into the archive, either automatically or manually, to provide searchable data. Non-limiting examples of activities entered into the archive include any activity described herein.

A system of the invention provides a convenient and reliable method whereby a healthcare provider can track all patients currently served by the provider, and check each patient's schedule of upcoming events. The system also provides the healthcare provider with options and reminders for tasks to perform at the arrival, departure, or discharge of a certain patient or a patient with a certain indication. For example, the system can provide a reminder to ask the patient if a prescription needs to be refilled.

A user can build a healthcare regimen for a patient using a system of the invention. A healthcare regimen, broadly, encompasses the medications, medical orders, procedures, encounters, and schedules describing the treatment and care of a patient. The user can search for therapies corresponding to a new patient's diagnosis, or even search for therapies that are currently in use for the same diagnosis at the user's healthcare facility. The system can provide a list of healthcare options, and the user can build a regimen for the patient simply by scrolling the list and clicking icons to add the healthcare options to the patient's regimen. The patient's regimen appears in a new file associated with the patient's profile, and the regimen is accessible to all users on the same network. Other users with permissions to modify a healthcare regimen can modify the regimen and make changes to the file. All changes made are visible to all users.

A user can browse a list of patients served by a certain healthcare facility. The user can add new patients, edit the profiles of the existing patients, or delete old patients, as is appropriate for maintaining accurate clinical records in accordance with the prevailing regulations.

A user can search for, generate, and browse a list of all encounters that a patient has had with healthcare providers or other support staff at the healthcare facility. The user can examine these records to evaluate the patient's current status and assess what the patient needs in the forthcoming encounters.

In some embodiments, the search system can be restricted by careful use of search parameters to limit or eliminate unexpected search results. A user can also modulate the level of the unexpected search results to find few, some, or many unexpected search results in addition to the desired, expected search results.

The invention is designed to be compliant with both data interoperability and security standards. The invention recognizes and supports the mandate that Electronic Health Records (EHRs) should be safely and securely accessible as Personally Controlled Health Records (PCHRs) by patients and their physicians. Consequently, some embodiments of invention are compliant with HL-7 as well as commercial Web standards to permit sustainable cross-platform data access.

Aspects of the invention provide improvements in healthcare—better patient outcomes; decreased cost of healthcare through reduction in medical errors, length of hospital stays, re-admissions, redundant tests and procedures; more accurate billing, increase in physician, patient and provider satisfaction; increase in revenue through prompted and more accurate coding; increase in efficiency of medical staff through improved access to information, capacity to prioritize, and access to alerts and updating functions; and overall improvement in clinical outcomes.

In some embodiments, an increase in efficiency is provided. In some embodiments, the invention allows medical staff to focus their time and energy on treating patients rather than searching for patient health information. In some embodiments, the invention enables improvement in patient outcomes and patient satisfaction.

In some embodiments, the invention reduces the cost of health care locally, regionally, or nationally. In some embodiments, the invention reduces risk to the patient, thereby optionally reducing the costs associated with malpractice suits and insurance premiums. In some embodiments, the invention facilitates access to funds available for services provided.

In some embodiments, the invention is used in a hospital setting. In some embodiments, the invention is used outside a hospital setting. In some embodiments, the invention is used in a patient's home. In some embodiments, the invention enables communication between a hospital and a patient's home. In some embodiments, the invention is used in a satellite clinical and care management facility. In some embodiments, the invention is used in a nursing facility. In some embodiments, the invention is used in a hospice and palliative care facility. In some embodiments, the invention is used in a clinic. In some embodiments, the invention is used in an ambulatory surgery center. In some embodiments, the invention is used in a temporary emergency off-site facility. In some embodiments, the invention is used in a government institution. In some embodiments, the invention is used in a correctional facility.

In some embodiments, the system can search reference materials. The reference materials can be medical, clinical, scientific, pharmacological, nursing, or veterinary reference materials.

In some embodiments, the invention supports diagnosis, treatment, decision-making, and monitoring, thereby improving outcomes.

In some embodiments, the invention supports pandemic response and large-scale disaster management, facilitating patient identification, triage, treatment and tracking.

In some embodiments, the invention provides clinical documentation via prompts.

In some embodiments, the invention improves work flow and productivity.

In some embodiments, the invention is HIPAA compliant.

In some embodiments, devices, systems, and methods of the instant invention provide the ability to access, retrieve, process, and display the aspects described in Table 1. The aspects of Table 1 comprise non-limiting examples, and the intended scope of the instant invention includes various embodiments not explicitly described herein.

TABLE 1
Access to underlying data
Context-driven access to relevant information by user type; user types include:
Department Head; Hospitalist; Primary Care Provider; Specialist; Nurse; Patient;
Patient family; Caregiver; Security
Thin client data access - no data resident on user device
Multi-level HIPAA compliant password-protected security
Physician context-driven access
Full patient list ranked by severity
Initial full patient display with critical vital sign information including: temperature;
blood pressure; pulse; pulse oximetry; and respiration rate
Individual patient detail, including: patient picture; age; known allergies
All vital signs color coded for abnormalities
All vital signs viewable as trended values based on user defined time frames
(for example, 24 hours, 48 hours, 72 hours, etc.)
All vital signs either normative, or physician-defined thresholds can be set for
specific vital signs and/or specific patients
Multiple vital sign trends can be selected by the user and displayed on the same
graph
All additional relevant biometric data can be accessed and displayed using the
methods described herein
Encounter report for access to all encounter-related information
Total alerts list with alert detail
Alerts driven by normative or caregiver specified values
Phone list showing all members of patient care management team with telephone
numbers with direct-dial functionality for: Primary Care Provider; Specialist(s);
Hospitalist; Nurse; Nurse's station
Direct-dial to dictation service with auto-fill for patient name, ID, and if applicable,
specific record
Ability to dictate physician and nursing notes for input into the patient record
Possible diagnoses - list generated using algorithmic search; exemplary, non-limiting
suggested diagnoses include: chronic heart failure; anemia; diabetes; and sepsis
Alert events list with access to user-defined trended information
Medications administered list showing: all medications from all sources (multiple
databases); last dose (amount and time); total doses administered in previous 24 hours
(number and cumulative amount); and total doses by medication type during user-
defined timeframe (for example, 24 hours, 48 hours, 72 hours)
Ability to render patient encounter information as a static document (for example,
.pdf format) for transfer to, for example: primary care provider; specialist; nursing
home; and Personally Controlled Health Record - PCHR (for example, Google
Health ™ and Microsoft HealthVault ™)
Search of all patient records regardless of data repository with appropriate
permissions
Access to multiple hospital database systems
Ability to make auto-dialed physicians and nurse's notes part of the patient's record
Ability to semantically browse transcribed physicians and doctors and nurses' notes
for user defined information
Prompts for required and/or desirable physician and patient actions, for example:
smoking cessation; exercise/physical therapy; dietary restrictions; prompts for
appropriate coding and billing; possible diagnoses; severity scales (with or without
complications); ICD-9 codes; prompts for comprehensive documentation for patient
transfers and/or discharges; medication lists/prescriptions; durable medical equipment;
physical therapy; and special orders and/or instructions
Permits remote independent physician data access to hospital data systems
Facilitates patient information exchange between regional health information
organizations
Provides access to external sources of information including web-based resources
Facilitates acquisition of Meaningful Use and other required health reports and
statistics including: ability to prompt, capture, analyze, and report; smoking cessation;
avoidable medical errors; and readmissions
Field communications hub for discharge/health care provider deployment
Patient specific configuration
Biometric peripheral wi-fi communications
global positioning system (GPS) patient tracking
Video teleconferencing
Patient disease management plan
Personal Emergency Response System (PERS)
Nutritional regimen
Inventory
Supply deliveries
Scheduled future supply deliveries

In some embodiments, the invention provides a method of accessing data from a plurality of independent data sources, the method comprising using a device to operate a faceted search system to: a) access, retrieve, process, and display data from the plurality of independent data sources; b) perform context-free transformations using data from the independent data sources; c) correlate data from the independent data sources; and d) query and present information in a user-defined format without a query tool that can interpret or reference a boundary descriptor or a format of the source data.

In some embodiments, the device creates virtual documents with a shared context.

In some embodiments, the virtual documents are dynamically configured to meet a user-defined format.

In some embodiments, at least one independent data source stores health records and/or medical information.

In some embodiments, at least one independent data source is a medical record database, a medical legacy silo, a patient record, a medical monitoring device, a laboratory database, or a reference manual.

In some embodiments, the device does not map any portion of the device to any portion of the independent data sources.

In some embodiments, the device is a computer, a personal data assistant, or a cellular phone.

In some embodiments, the device does not download or store information that was accessed, retrieved, processed, or displayed.

In some embodiments, the independent data sources have schema that are the same, similar, or different.

In some embodiments, the device displays a dashboard configured to convey healthcare-related information.

In some embodiments, the device provides graphical descriptions of data.

In some embodiments, the device autonomously repeats steps a)-d) using user-determined search terms at user-determined time intervals.

In some embodiments, the correlated data comprises a clinical value, a population characteristic, or a subject characteristic.

In some embodiments, the method further comprises alerting a user to a change in the clinical value, population characteristic, or subject characteristic by autonomously scanning one or more independent data sources to obtain a data point, comparing the data point to a pre-determined threshold value, and alerting the user that the data point has met the threshold value.

In some embodiments, the device provides a recommendation to a user based on the results of steps a)-d).

In some embodiments, the recommendation is a diagnosis, prescription, medical order, exercise, or instruction.

In some embodiments, the user can select the recommendation by clicking an icon, thereby adding the recommendation to a patient's health care regimen.

In some embodiments, the invention provides a device that is effective to: a) use faceted search to access, retrieve, process, and display data from a plurality of independent data sources; b) perform context-free transformations using data from the independent data sources; c) correlate data from the independent data sources; and d) query and present information in a user-defined format without a query tool that can interpret or reference a boundary descriptor or a format of the source data.

In some embodiments, at least one independent data source stores health records and/or medical information.

In some embodiments, the device is a computer, a personal data assistant, or a cellular phone.

In some embodiments, the device does not map any portion of the device to any portion of the independent data sources.

In some embodiments, the device creates virtual documents with a shared context.

In some embodiments, the virtual documents are dynamically configured to meet user-defined requirements.

### Embodiments

The following non-limiting embodiments provide examples of the invention, but do not define the scope of the invention.

Embodiment 1. A method of accessing data from a plurality of independent data sources, the method comprising using a device to operate a faceted search system to: a) access, retrieve, process, and display data from the plurality of independent data sources; b) perform context-free transformations using data from the independent data sources; c) correlate data from the independent data sources; and d) query and present information in a user-defined format without a query tool that can interpret or reference a boundary descriptor or a format of the source data.
Embodiment 2. The method of embodiment 1, wherein the device creates virtual documents with a shared context.
Embodiment 3. The method of embodiment 2, wherein the virtual documents are dynamically configured to meet a user-defined format.
Embodiment 4. The method of any one of embodiments 1-3, wherein at least one independent data source stores health records and/or medical information.
Embodiment 5. The method of any one of embodiments 1-4, wherein at least one independent data source is a medical record database, a medical legacy silo, a patient record, a medical monitoring device, a laboratory database, or a reference manual.
Embodiment 6. The method of any one of embodiments 1-5, wherein the device does not map any portion of the device to any portion of the independent data sources.
Embodiment 7. The method of any one of embodiments 1-6, wherein the device is a computer, a personal data assistant, or a cellular phone.
Embodiment 8. The method of any one of embodiments 1-7, wherein the device does not download or store information that was accessed, retrieved, processed, or displayed.
Embodiment 9. The method of any one of embodiments 1-8, wherein the independent data sources have schema that are the same, similar, or different.
Embodiment 10. The method of any one of embodiments 1-9, wherein the device displays a dashboard configured to convey healthcare-related information.
Embodiment 11. The method of any one of embodiments 1-10, wherein the device provides graphical descriptions of data.
Embodiment 12. The method of any one of embodiments 1-11, wherein the device autonomously repeats steps a)-d) using user-determined search terms at user-determined time intervals.
Embodiment 13. The method of any one of embodiments 1-12, wherein the correlated data comprises a clinical value, a population characteristic, or a subject characteristic.
Embodiment 14. The method of embodiment 13, further comprising alerting a user to a change in the clinical value, population characteristic, or subject characteristic by autonomously scanning one or more independent data sources to obtain a data point, comparing the data point to a pre-determined threshold value, and alerting the user that the data point has met the threshold value.
Embodiment 15. The method of any one of embodiments 1-14, wherein the device provides a recommendation to a user based on the results of steps a)-d).
Embodiment 16. The method of embodiment 15, wherein the recommendation is a diagnosis, prescription, medical order, exercise, or instruction.
Embodiment 17. The method of any one of embodiments 15 and 16, wherein the user can select the recommendation by clicking an icon, thereby adding the recommendation to a patient's health care regimen.
Embodiment 18. A device that is effective to: a) use faceted search to access, retrieve, process, and display data from a plurality of independent data sources; b) perform context-free transformations using data from the independent data sources; c) correlate data from the independent data sources; and d) query and present information in a user-defined format without a query tool that can interpret or reference a boundary descriptor or a format of the source data.
Embodiment 19. The device of embodiment 18, wherein at least one independent data source stores health records and/or medical information.
Embodiment 20. The device of any one of embodiments 18 and 19, wherein the device is a computer, a personal data assistant, or a cellular phone.
Embodiment 21. The device of any one of embodiments 18-20, wherein the device does not map any portion of the device to any portion of the independent data sources.
Embodiment 22. The device of any one of embodiments 18-21, wherein the device creates virtual documents with a shared context.
Embodiment 23. The device of embodiment 22, wherein the virtual documents are dynamically configured to meet user-defined requirements.

What is claimed is:

1. A method of accessing data from a plurality of independent data sources, the method comprising using a device to operate a faceted search system to:
a) access, retrieve, process, and display data from the plurality of independent data sources;
b) perform context-free transformations using data from the independent data sources;
c) correlate data from the independent data sources; and
d) query and present information in a user-defined format without a query tool that can interpret or reference a boundary descriptor or a format of the source data.

2. The method of claim 1, wherein the device creates virtual documents with a shared context.

3. The method of claim 2, wherein the virtual documents are dynamically configured to meet a user-defined format.

4. The method of claim 1, wherein at least one independent data source stores health records and/or medical information.

5. The method of claim 1, wherein at least one independent data source is a medical record database, a medical legacy silo, a patient record, a medical monitoring device, a laboratory database, or a reference manual.

6. The method of claim 1, wherein the device does not map any portion of the device to any portion of the independent data sources.

7. The method of claim 1, wherein the device is a computer, a personal data assistant, or a cellular phone.

8. The method of claim 1, wherein the device does not download or store information that was accessed, retrieved, processed, or displayed.

9. The method of claim 1, wherein the independent data sources have schema that are the same, similar, or different.

10. The method of claim 1, wherein the device displays a dashboard configured to convey healthcare-related information.

11. The method of claim 1, wherein the device provides graphical descriptions of data.

12. The method of claim 1, wherein the device autonomously repeats steps a)-d) using user-determined search terms at user-determined time intervals.

13. The method of claim 1, wherein the correlated data comprises a clinical value, a population characteristic, or a subject characteristic.

14. The method of claim 13, further comprising alerting a user to a change in the clinical value, population characteristic, or subject characteristic by autonomously scanning one or more independent data sources to obtain a data point, comparing the data point to a pre-determined threshold value, and alerting the user that the data point has met the threshold value.

15. The method of claim 1, wherein the device provides a recommendation to a user based on the results of steps a)-d).

16. The method of claim 15, wherein the recommendation is a diagnosis, prescription, medical order, exercise, or instruction.

17. The method of claim 15, wherein the user can select the recommendation by clicking an icon, thereby adding the recommendation to a patient's health care regimen.

18. A device that is effective to:
a) use faceted search to access, retrieve, process, and display data from a plurality of independent data sources;
b) perform context-free transformations using data from the independent data sources;
c) correlate data from the independent data sources; and
d) query and present information in a user-defined format without a query tool that can interpret or reference a boundary descriptor or a format of the source data.

19. The device of claim 18, wherein at least one independent data source stores health records and/or medical information.

20. The device of claim 18, wherein the device is a computer, a personal data assistant, or a cellular phone.

21. The device of claim 18, wherein the device does not map any portion of the device to any portion of the independent data sources.

22. The device of claim 18, wherein the device creates virtual documents with a shared context.

23. The device of claim 22, wherein the virtual documents are dynamically configured to meet user-defined requirements.
